(19) United States
(12) Patent Application Publication
(10) Pub. No.: US 2015/0102639 A1
(43) Pub. Date: Apr. 16, 2015

(54) VEHICLE-BODY MEMBER JOINING STRUCTURE AND VEHICLE-BODY STRUCTURE

(71) Applicant: TOYOTA JIDOSHA KABUSHIKI KAISHA, Toyota-shi (JP)

(72) Inventors: Hideyuki YOSHIOKA, Toyota-shi (JP); Akiyoshi WATANABE, Toyota-shi (JP); Norimasa KOREISHI, Toyota-shi (JP); Kentaro ADACHI, Toyota-shi (JP)

(21) Appl. No.: 14/513,711

(22) Filed: Oct. 14, 2014

(30) Foreign Application Priority Data
Oct. 16, 2013 (JP) 2013-215571

(51) Int. Cl. B62D 27/02; B62D 25/08

(52) U.S. Cl. CPC B62D 27/023; B62D 25/081
USPC 296/192

(57) ABSTRACT

A vehicle-body member joining structure includes: laser welded portions at which at least two panel members each constituting part of a vehicle body and made of a steel sheet are joined to each other by laser welding in a state where a predetermined gap is formed therebetween; and an electrodeposition coating film portion covering surfaces of the panel members and filling at least part of the gap.

### INCORPORATION BY REFERENCE

The disclosure of Japanese Patent Application No. 2013-215571 filed on Oct. 16, 2013 including the specification, drawings and abstract is incorporated herein by reference in its entirety.

### BACKGROUND OF THE INVENTION

1. Field of the Invention

The present invention relates to a vehicle-body member joining structure and a vehicle-body structure.

2. Description of Related Art

For example, Japanese Patent No. 3223746 describes a technique to form a vehicle framework having a closed section by performing spot welding on flanges of an inner member (a panel member) and an outer member (a panel member). Herein, an interval between spots subjected to the spot welding is narrowed so as to increase rigidity of the framework.

However, in general, a gap between the inner member and the outer member is almost zero around a spot-welded portion. For this reason, there is a possibility that ED coating liquid (electrodeposition coating; base coat for rust inhibition) does not enter the gap. In this case, an adhesion effect due to the ED coating cannot be obtained.

### SUMMARY OF THE INVENTION

The present invention provides a vehicle-body member joining structure and a vehicle-body structure each of which is able to obtain an adhesion effect due to electrodeposition coating.

A first aspect of the present invention relates to a vehicle-body member joining structure. The vehicle-body member joining structure includes: laser welded portions at which at least two panel members each constituting part of a vehicle body and made of a steel sheet are joined to each other by laser welding in a state where a predetermined gap is formed therebetween; and an electrodeposition coating film portion covering surfaces of the panel members and filling at least part of the gap.

In the above aspect, at least two panel members each made of a steel sheet are joined to each other by the laser welding (at the laser welded portions) in a state where the predetermined gap is formed therebetween. Since the surfaces of the panel members are coated with the electrodeposition coating film portion, it is possible to obtain a rust inhibitive effect in the panel members. Further, at least part of the gap provided between the panel members is filled with the electrodeposition coating film portion, so that it is possible to obtain an adhesion effect between the panel members, due to the electrodeposition coating.

A second aspect of the present invention relates to a vehicle-body structure. The vehicle-body structure includes a vehicle-body member to which the vehicle-body member joining structure according to the above aspect is applied, the vehicle-body member being provided in a cowl portion, or its peripheral parts, for supporting a lower part of a front wind glass, or in an underbody constituting a lower part of a vehicle body.

In the above aspect, since an antirust effect is improved, it is possible to apply the vehicle-body member joining structure according to the above aspect to parts often splashed with water, such as the cowl portion or its peripheral parts, the underbody, and so on.

As described above, the first aspect has an excellent effect that an adhesion effect due to the electrodeposition coating is obtainable.

The second aspect has an excellent effect that an antirust effect can be improved in the parts often splashed with water.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a vehicle body to which a vehicle-body member joining structure according to an embodiment of the present invention is applied;

FIG. 2A is a perspective view illustrating an essential part of a panel member to which the vehicle-body member joining structure according to the embodiment of the present invention is applied;

FIG. 2B is a sectional view taken along a line IIB-IIB of FIG. 2A and illustrating an essential part of the panel member to which the vehicle-body member joining structure according to the embodiment of the present invention is applied;

FIG. 3A is a perspective view illustrating a comparative example, and corresponds to FIG. 2A; and

FIG. 3B is a perspective view illustrating a comparative example, and corresponds to FIG. 2B.

### DETAILED DESCRIPTION OF EMBODIMENTS

A vehicle-body member joining structure according to an embodiment of the present invention is described below with reference to the drawings. Note that a front side in a vehicle longitudinal direction is indicated by an arrow FR, a vehicle width direction is indicated by an arrow W, and an upper side in a vehicle up-down direction is indicated by an arrow UP. Further, in the following description, in a case where front and rear directions and up and down directions are used without any special mention, they indicate front and rear in the vehicle longitudinal direction, and up and down of the vehicle up-down direction, respectively.

### (Configuration of Vehicle-body Member Joining Structure)

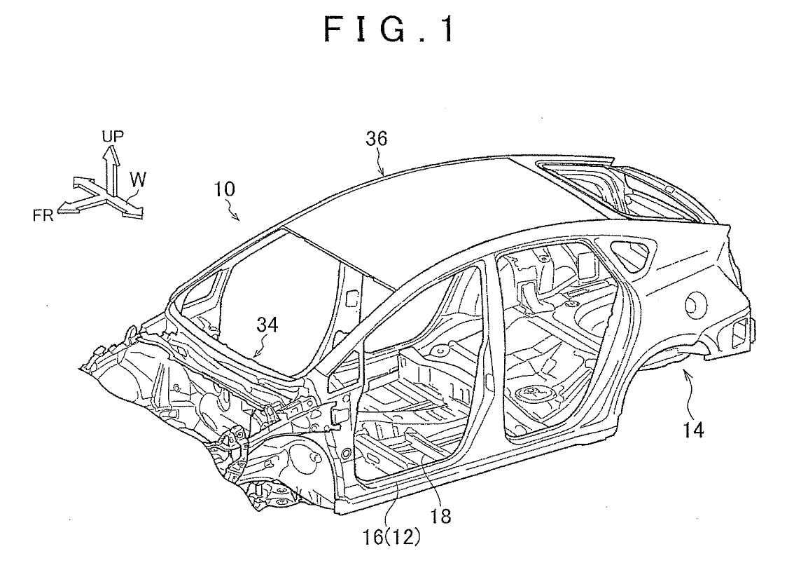

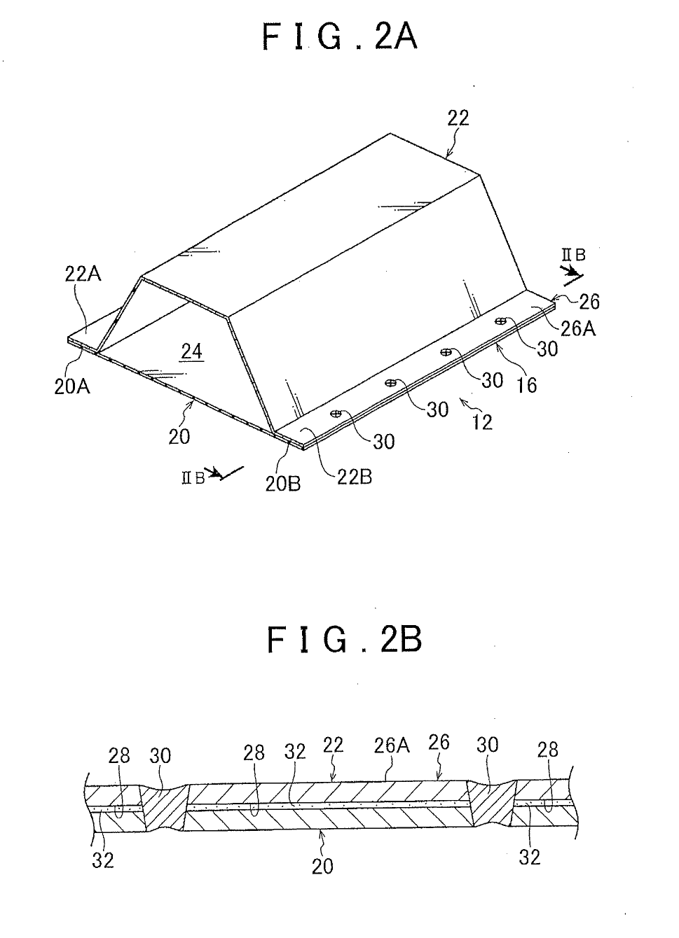

As illustrated in FIG. 1, a vehicle-body member joining structure 12 according to the present embodiment is applied to an underbody 14 constituting a lower part of a vehicle body 10. As an example of a panel member in the present embodiment, a rocker 16 is described. As illustrated in FIG. 2A, the rocker 16 is extended along the vehicle longitudinal direction outside a floor panel 18 which constitutes part of a vehicle lower portion in the vehicle width direction.

The rocker 16 includes a cowl side panel 20 (hereinafter referred to as the “panel member 20”) disposed on an inner side in the vehicle width direction, and a rocker outer reinforcement 22 (hereinafter referred to as the “panel member 22”) disposed on an outer side of the panel member 20 in the vehicle width direction. Further, a side outer panel (not shown) is provided on an outer side of the panel member 22 in the vehicle width direction, and constitutes part of a design of the vehicle lower portion.

The panel member 20 and the panel member 22 are each made of a steel sheet having an elongated shape, and a plane sectional shape of the panel member 20 along a width direction perpendicular to its longitudinal direction has a flat-plate shape. In the meantime, the panel member 22 has a hat-like shape that is opened inwardly in the vehicle width direction. Note that the side outer panel has generally the same configuration as the panel member 22, so that the side outer panel itself is not particularly described herein.

Flange portions 20A, 20B are provided on respective ends of the panel member 20 in its width direction, and flange portions 22A, 22B are provided on respective ends of the panel member 22 in its width direction. The flange portions 20A, 22A of the panel members 20, 22 are superimposed on each other to be joined, and the flange portion 20B, 22B of the panel members 20, 22 are superimposed on each other to be joined. Hereby, a closed-section portion 24 is formed in the rocker 16.

Here, the panel members 20, 22 are joined to each other by laser beam welding, and a joining surface 26A subjected to the laser beam welding is one continuous flat surface. Note that the laser beam welding includes LSW (laser screw welding), line laser welding, and so on.

As described above, after the panel members 20, 22 are joined to each other, electrodeposition coating (so-called ED coating) is performed on a vehicle body including the rocker 16. Although not illustrated herein, the vehicle body is dipped into a tank filled with an electrodeposition coating material, and a voltage is applied between the vehicle body and an electrode in the tank so as to flow a current therethrough. Hereby, a coating film is precipitated. After that, the vehicle body is taken out of the tank and washed in water to remove excessive coating. Subsequently, a hardening process of the coating is performed. Note that, since the electrodeposition coating is base coat, finish coating for decoration will be performed on the vehicle body.

### (Operation/Effect of Vehicle-body Member Joining Structure)

Next will be described an operation/effect of the abovementioned vehicle-body member joining structure.

As illustrated in FIGS. 2A, 2B, the panel members 20, 22 in the rocker 16 are joined to each other by laser beam welding,

Although not illustrated herein, spot welding is generally performed such that: while panel members are sandwiched and pressed by a pair of spot guns, a current is flowed between the pair of spot guns, thereby welding the panel members. Since the panel member are sandwiched and pressed in the spot welding as such, no gap may be provided between the panel members. If no gap is provided between the panel members, electrodeposition coating liquid may not enter therebetween around spot-welded portions.

In the meantime, in the laser beam welding, it is possible to perform welding on the panel members 20, 22 in a state where a gap 28 is provided therebetween, as illustrated in FIGS. 2A, 2B. In view of this, in the present embodiment, the panel member 20 is joined to the panel member 22 by the laser beam welding (laser welded portions 30).

When the predetermined gap 28 is provided as such, the electrodeposition coating liquid can enter the gap 28. This makes it possible to attach the electrodeposition coating liquid to surfaces of the panel members 20, 22, thereby resulting in that the surfaces of the panel members 20, 22 can be coated with an electrodeposition coating film. This makes it possible to improve a rust inhibitive effect. Particularly, the present invention is effectively applicable to parts often splashed with water, such as the rocker 16.

Further, when the electrodeposition coating liquid is hardened, an effect like adhesives can be obtained, thereby resulting in that bonding in a joining portion 26 in the rocker 16 is strengthened. This increases rigidity of the rocker 16. In the present embodiment, when the electrodeposition coating liquid enters the predetermined gap 28, a space between the panel member 20 and the panel member 22 is filled up with the electrodeposition coating film (an electrodeposition coating film portion 32).

Accordingly, an adhesion effect can be obtained between the panel member 20 and the panel member 22 due to the electrodeposition coating film portion 32.

Note that the predetermined gap 28 here is approximately 0.1 to 0.3 mm, for example. In the present embodiment, the gap 28 is provided in a state where the panel member 20 and the panel member 22 are superimposed on each other. Alternatively, projection portions (not shown) may be provided on that side of the panel member 20 or the panel member'22 which faces its counter member. Further, in the laser beam welding, a plate-shaped metal shim jig (not shown) may be inserted between the panel member 20 and the panel member 22. However, the shim jig is removed after the laser beam welding is finished.

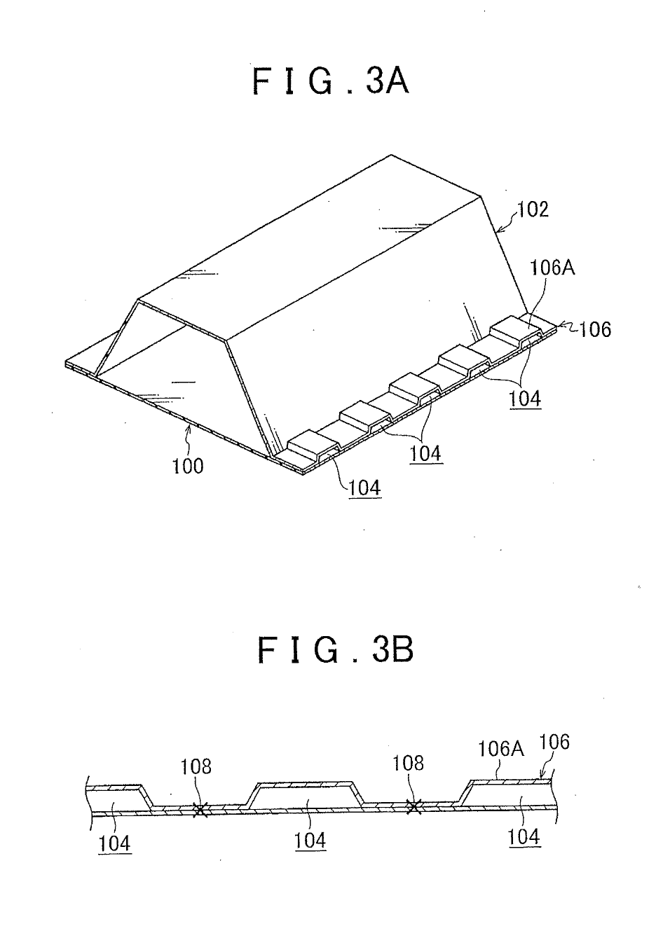

Further, in the present embodiment, the joining surface 26A subjected to the laser beam welding is one continuous flat surface. In a case of the spot welding in which panel members are joined to each other in a state where the panel members are pressed by spot guns, no gap may be provided between panel members 100, 102 as illustrated in FIGS. 3A, 3B. For this reason, it is necessary to form a controlled seating face 106 to provide gaps 104. As a result, a joining surface 106A subjected to the spot welding (spot-welded portions 108) has an irregular shape. That is, the joining surface 106A is not one continuous surface.

In the meantime, in a case of the laser beam welding, since the panel members 20, 22 can be welded in a state where the predetermined gap 28 is formed as illustrated in FIG. 2B, it is possible to form the joining surface 26A for the laser welded portions 30 as one continuous surface, as described above. As such, in the present embodiment, since it is not necessary to form a controlled seating face to provide the gap 28 between the panel members 20, 22, it is possible to improve rigidity in the rocker 16. Further, since it is not necessary to form the controlled seating face, it is possible to reduce a mold cost to form a vehicle-body member.

Note that the present embodiment deals with the rocker 16, but the present invention is also applicable to frame members other than the rocker 16 in the underbody 14 illustrated in FIG. 1, and a cowl portion 34, or its peripheral parts, for supporting a lower part of a front wind glass. Further, the present invention may be applied to an upper body 36 constituting an upper part of the vehicle body 10.

Further, in the present embodiment, as illustrated in FIGS. 2A, 2B, the joining surface 26A subjected to the laser beam welding is one continuous flat surface in the panel members 20, 22. However, the joining surface 26A may be a curved surface. Further, the present embodiment deals with the joining between two panel members, but three panel members may be joined to each other.

One embodiment of the present invention has been described above, but the present invention is not limited to the above and may be modified in various ways to be performed as long as the modified examples are not beyond the gist thereof.

What is claimed is:

1. A vehicle-body member joining structure comprising:
laser welded portions at which at least two panel members each constituting part of a vehicle body and made of a steel sheet are joined to each other by laser welding in a state where a predetermined gap is formed therebetween; and
an electrodeposition coating film portion covering surfaces of the panel members and filling at least part of the gap.

2. The vehicle-body member joining structure according to claim 1, wherein:
a joining surface subjected to the laser welded portion is formed as one continuous surface.

3. A vehicle-body structure comprising:
a vehicle-body member to which the vehicle-body member joining structure according to claim 1 is applied, the vehicle-body member being provided in a cowl portion, or its peripheral parts, for supporting a lower part of a front, wind glass, or in an underbody constituting a lower part of a vehicle body.
